(19) United States
(12) Patent Application Publication
(10) Pub. No.: US 2016/0067785 A1
(43) Pub. Date: Mar. 10, 2016

(54) Cutting inserts with honeycomb sandwich structure for cooling

(71) Applicants: Andrew T. Wang, Henderson, NV (US); Zhiyong Wang, Henderson, NV (US)

(72) Inventors: Andrew T. Wang, Henderson, NV (US); Zhiyong Wang, Henderson, NV (US)

(21) Appl. No.: 14/480,977

(22) Filed: Sep. 9, 2014

(51) Int. Cl. B23B 27/10; E21B 10/62

(52) U.S. Cl. CPC B23B 27/10; E21B 10/62; B23B 2228/36; B23B 2250/12

(57) ABSTRACT

A new type of cutting insert is disclosed here which has sandwich structure often with honeycombs in the mid-section of the insert, to allow fluid and/or gas coolant flow through the insert from inside and reduce cutting tool temperature during work-piece cutting operation. The cutting insert includes an insert body, which includes cutting edge, nose, rake face, and flank face. The cutting insert body further contains interior coolant passageways formed by specially manufactured honeycomb structure in the insert body. The number, shape, and size of honeycomb interior passageways are carefully developed and distributed inside the insert body. Therefore, the insert provides adequate strength to withstand force and impact from cutting work-piece and also in the meantime provides effective cooling to the cutting tool. The honeycomb interior coolant passageways could be connected from the insert to the tool holder through an internal passageway in the tool holder, then to the coolant circulation system provided to the cutting tool, or directly connected to an external coolant circulation system. The cutting insert can be used in metal cutting, such as high strength aerospace materials and heat resistance materials. It can also be used in drilling tools for mine/oil/natural gas exploration.

### BACKGROUND OF THE INVENTION

The invention relates to a cutting insert, which has honeycomb internal structure and/or internal channel(s) and pin hole(s) on rake and flank faces adjacent to cutting edge for coolant delivery, and an assembly using the cutting insert for use in the chip forming removal of material from a work-piece. More specifically, the invention pertains to a cutting insert, as well as an assembly using the cutting insert, used for chip-forming material removal operations wherein there is enhanced delivery of coolant to the insert and the interface between the cutting insert and the work-piece (i.e., the insert-chip interface) to diminish excessive heat at the insert-chip interface.

In a chip-forming material removal operation (such as turning, milling, drilling, grinding, and the like), heat is generated mostly at the interface between the cutting insert rake face and the newly formed chip surface, the interface between the insert flank face and the newly formed work-piece surface, and the shear plane which starts at the insert nose area and separates the work-piece from the chip. It is known that over 90% of the energy in cutting operation converts into heat in the cutting zone and causes rapid tool wear and crack development in cutting insert, which leads to short tool life and poor cutting quality on work-piece. Therefore, any meaningful way of dissipating heat generated in cutting operation could lead to significant improve in cutting tool life and machine quality on work-piece. This is especially true in machining advanced materials, such as titanium alloys, Inconel alloys, metal matrix composite (MMC), and ceramic materials, where the heat generation is more intense.

U.S. Pat. No. 6,053,669 to Lagerberg for CHIP FORMING CUTTING INSERT WITH INTERNAL COOLING discusses the importance of reducing the heat at the insert-chip interface. Lagerberg mentions that when the cutting insert is made from cemented carbide reaches a certain temperature, its resistance to plastic deformation decreases. A decrease in plastic deformation resistance increases the risk for breakage of the cutting insert. U.S. Pat. No. 5,775,854 to Wertheim for METAL CUTTING TOOL points out that a rise in the working temperature leads to a decrease in hardness of the cutting insert. The consequence is an increase in wear of the cutting insert.

U.S. Pat. No. 8,328,471 to Nelson, et. al. for CUTTING INSERT WITH INTERNAL COOLANT DELIVERY AND CUTTING ASSEMBLY USING THE SAME, revealed A metal cutting insert that contains a distinct interior coolant passage communicating with the discrete cutting location. The distinct interior coolant passage has a coolant passage inlet defining a coolant passage inlet cross-sectional area, a coolant passage discharge defining a coolant passage discharge cross-sectional area, and an axial coolant passage length. The distinct interior coolant passage defines a coolant flow cross-sectional area along the axial coolant passage length thereof. The coolant passage inlet cross-sectional area is substantially the same as the coolant passage discharge cross-sectional area. The geometry of the coolant flow area changes along the axial coolant passage length.

U.S. Pat. No. 8,387,245 to Bunker, et al. for COMPONENTS WITH RE-ENTRANT SHAPED COOLING CHANNELS AND METHODS OF MANUFACTURE discusses a method of forming one or more grooves in a surface of a substrate, where the substrate has at least one hollow interior space. Each of the one or more grooves extends at least partially along the substrate surface and has a base and a top. The base is wider than the top, such that each of the one or more grooves comprises a re-entrant shaped groove. The method further includes forming one or more access holes through the base of a respective groove, to connect the groove in fluid communication with respective ones of the hollow interior space(s), and disposing a coating over at least a portion of the substrate surface.

U.S. Pat. No. 8,439,608 to Chen, et al. for SHIM FOR A CUTTING INSERT AND CUTTING INSERT-SHIM ASSEMBLY WITH INTERNAL COOLANT DELIVERY presents a cutting insert-shim assembly that has a cutting insert with a bottom surface and a plurality of interior coolant passages wherein each interior coolant passage has a coolant inlet in the bottom surface of the cutting insert. The shim has a first side surface and a second side surface and contains a cavity, which communicates with the coolant conduit. The cavity defines a first opening in the first side surface and a second opening in the second side surface. When the shim is in a first condition, the first side surface contacts the bottom surface of the cutting insert and the first opening provides a first level of coolant communication to the interior coolant passages in the cutting insert. When the shim is in a second condition, the second side surface contacts the bottom surface of the cutting insert and the second opening provides a second level of coolant communication to the interior coolant passages in the cutting insert.

Patent application Ser. No. 12/885,123 to Endres for CUTTING TOOL INSERT HAVING INTERNAL MICRODUCT FOR COOLANT discusses a cutting tool insert with a cooling microduct within the body. The microduct has a cross-sectional area of not more than 1.0 square millimeter. The microduct is adapted to permit the flow of a coolant therethrough to transfer heat away from the cutting edge and extend the useful life of the insert. The microduct may have a portion with a cross-sectional area no larger than 0.004 square millimeter, and may communicate through at least one of the rake fact and the flank face to exhaust coolant near the cutting edge and further enhance cooling.

U.S. Pat. No. 8,439,609 to Woodruff, et al. for MICRO-JET COOLING OF CUTTING TOOLS discusses a cutting tool including micro-nozzles formed in at least one of the tool body and the insert, and aimed at the cutting edge. Each micro-nozzle generates a micro jet of cutting fluid in close proximity to the cutting edge and adjacent to at least one of the flank face and the rake face.

U.S. Pat. No. 7,625,157 to Prichard et al. for MILLING CUTTER AND MILLING INSERT WITH COOLANT DELIVERY pertains to a cutting insert that includes a cutting body with a central coolant inlet. The cutting insert further includes a positionable diverter. The diverter has a coolant trough, which diverts coolant to a specific cutting location. U.S. Patent Application Publication No. US 2008-0175678 A1 to Prichard et al. for METAL CUTTING SYSTEM FOR EFFECTIVE COOLANT DELIVERY pertains to a cutting insert that functions in conjunction with a top piece and/or a shim to facilitate delivery of coolant to a cutting location.

U.S. Pat. No. 6,045,300 to Antoun for TOOL HOLDER WITH INTEGRAL COOLANT PASSAGE AND REPLACEABLE NOZZLE discloses using high pressure and high volume delivery of coolant to address heat at the insert-chip interface. U.S. Pat. No. 6,652,200 to Kraemer for a TOOL HOLDER WITH COOLANT SYSTEM discloses grooves between the cutting insert and a top plate. Coolant flows through the grooves to address the heat at the insert-chip interface. U.S. Pat. No. 5,901,623 to Hong for CRYOGENIC MACHINING discloses a coolant delivery system for applying liquid nitrogen to the insert-chip interface.

U.S. Pat. No. 5,237,894 describes a cutting insert with a transverse, open channel for cooling liquid which terminates in an opening on the upper side of the cutting insert.

U.S. Pat. No. 6,053,669 pertains to a cutting insert with internal coolant for chip removing machining is limited by an upper side, an underside and at least a side surface between these. The cutting insert comprises partly an edge in the area of the said upper surface. A supporting body with honeycomb material structure through which pores the cooling medium can flow serves as a means to guide the cooling medium, the supporting body is at least partly enveloped by a surface shell with impermeable, non-honeycomb material structure. In this surface layer are found at least two openings which expose the supporting body's honeycomb structure outwards, namely a first, localised at a distance from the cutting edge opening which serves as a entrance for the inflow of the cooling medium to the inside of the supporting body, and a second, which serves as outlet for the cooling medium from the honeycomb inner of the supporting body opening which is situated near the cutting edge.

It is readily apparent that in a chip forming and material removal operation, higher operating temperatures at the insert-chip interface can have a detrimental impact on the useful tool life through premature breakage and/or excessive wear. It would be highly desirable to provide a cutting insert used for chip forming material removal operations wherein there is an improved delivery of coolant to the interface between the cutting insert and the work-piece (i.e., the insert-chip interface), which is the location on the work-piece where the chip is generated). There would be a number of advantages connected with the improved delivery of coolant to the insert-chip interface.

In a chip forming material removal operation, the chip generated from the work-piece can sometimes stick (e.g., through welding) to the surface of the cutting insert. The buildup of chip material on the cutting insert in this fashion is an undesirable occurrence that can negatively impact upon the performance of the cutting insert, and hence, the overall material removal operation. It would be highly desirable to provide a cutting insert used for chip forming material removal operations wherein there is enhanced delivery of coolant to the insert-chip interface so as to result in enhanced lubrication at the insert-chip interface. The consequence of enhanced lubrication at the insert-chip interface is a decrease in the tendency of the chip to stick to the cutting insert.

In a chip forming material removal operation, there can occur instances in which the chips do not exit the region of the insert-chip interface when the chip sticks to the cutting insert. When a chip does not exit the region of the insert-chip interface, there is the potential that a chip can be re-cut. It is undesirable for the milling insert to re-cut a chip already removed from the work-piece. A flow of coolant to the insert-chip interface will facilitate the evacuation of chips from the insert-chip interface thereby minimizing the potential that a chip will be re-cut. It would be highly desirable to provide a cutting insert used for chip forming material removal operations wherein there is enhanced delivery of coolant to the insert-chip interface to reduce the potential that a chip will be re-cut. The consequence of enhanced flow of coolant to the insert-chip interface is better evacuation of chips from the vicinity of the interface with a consequent reduction in the potential to re-cut a chip.

A number of factors can impact the extent of the coolant delivered to the insert-chip interface. For example, the size of the structure that conveys the coolant to the cutting insert can be a limiting factor on the extent of coolant supplied to the cutting insert. Thus, it would be highly desirable to provide supply holes that are equal to or larger than the inlets in the cutting insert to maximize the flow of the coolant to the cutting insert. It would be highly desirable to provide a cutting insert in which two or more coolant channels convey coolant to a single discrete cutting location. Further, in order to customize the delivery of coolant, the use of irregular coolant channels and variable areas of the inlet and the discharge in the cutting insert which allow for such customization. One such feature is to provide for a range of diversion angles of the coolant, which can range between about 10 degrees and about 60 degrees

In order to enhance delivery of coolant, it is advantageous to provide for the coolant to enter the cutting insert through the holder. This can include the use of an external coolant supply or an internal coolant supply

In reference to the manufacturing of a cutting insert, there can be advantages in using multiple pieces, which together form the cutting insert. For example, in some instances a cutting insert formed from a base, which presents the cutting edge, and a core can result in enhanced longevity because only the base need to be changed after reaching the end of the useful tool life. In such an arrangement, the core is detachably joins to the base whereby the core is re-used when the base wears out. The base and core can join together via co-sintering, brazing and/or gluing. As an alternative, the base and core can contact one another without joining together as an integral member, but remain separate components even though in close contact. In addition, to enhance performance, the base and the core can be from the same or dissimilar materials depending upon the specific application.

When the preferred embodiment of the cutting insert presents a round geometry, certain advantages can exist. For example, when the cutting insert has a round geometry, the assembly of multiple components, e.g., a base and a core, does not need indexing. A round cutting insert is not handed so it can be used in left, right and neutral. In profile turning, up to 50% of the round cutting insert can function as the cutting edge. A round cutting insert is also available to engage an anti-rotation feature.

### SUMMARY OF THE INVENTION

In one form thereof, the invention is a cutting insert that is useful in chip forming and material removal from a work-piece. The cutting insert includes at least a cutting edge, nose, rake face, and flank face. The cutting insert body comprises honeycomb structure, often under its top surface, i.e., the rake face of the insert, to allow fluid and/or gas coolant flow through internally channeled insert and flow out the insert body. the honeycomb coolant passageway(s) inside an insert could be in size of a few nanometers to a few millimeters, and their distribution inside the insert body could be even distribution, or random distribution, or more channels in the middle section of the insert with less and maybe also smaller channels toward the insert surfaces, such as rake face and flank face of the insert. Therefore, the insert provides adequate strength to withstand force and impact from cutting work-piece and also in the meantime provides effective cooling result to the cutting tool. All the sides of the insert (not the top or the bottom) could be sealed or partially sealed to prevent coolant from being wasted by flowing out unnecessary areas, but leave internal channels open at certain places on the side of the insert, such as some portion of the nose and the flank face. The coolant flows through an inner passageway from the tool holder directly to the honeycomb channel open on the insert, which could be on the side, top, and/or bottom of the insert. Connectors could be used between the tool holder and the insert to allow quick installation and desirable coolant flow between them; or coolant could directly from an external coolant circulation system connected to the insert. The coolant could also flow in a loop back to the tool holder from the insert without coming out through the sides of the insert.

In another form thereof, the invention is a cutting assembly for use in chip forming and material removal from a work-piece wherein a coolant source supplies coolant to the cutting assembly, the cutting assembly comprising: a tool holder comprising an internal channel as coolant passageway; the cutting insert comprising: a cutting insert body including cutting edge, nose, rake face, and flank face; a shim which is under the cutting insert; an aperture for receiving a fastener (called lock pin sometimes); the cutting insert body further containing honeycomb structure inside allowing coolant passing through itself. However, the outside of the insert, including most part of the top face and the bottom face are not coolant permissible, except some locations on the rake face and flank face, and also some portions on the side of the insert are also in honeycomb structure, allowing coolant going in from the tool holder.

Cutting insert internal stresses are calculated with the formula below for honeycomb structure and solid structure, respectively. FIG. 1 is used to illustrate relationship of cutting insert, chip, and work-piece material.

Knowing that equations 1, 2, and 3 give radial stresses, where zero tangential stress, and zero shear stress indicate that σᵣ is the principle stress, or the maximum stress.

Calculation indicates a wide range of honeycomb structure arrangement could offer adequate strength to the insert for cutting advanced materials and in the meantime maintain effective cooling to the tool.

### BRIEF DESCRIPTION OF THE DRAWINGS

The following is a brief description of the drawings that form a part of this patent application:

FIG. 1 is a two dimensional view of a tool in cutting work-piece material, where chip is separated from the work-piece by the rake face of the cutting tool.

FIG. 2 is an isometric view of one specific embodiment of a cutting tool assembly wherein the cutting tool assembly has a cutting tool body that carries a cutting insert, a seat, a lock pin, a clamp, and a clamp screw in this specific embodiment;

FIG. 2A are isometric view of cutting inserts as example, where (a) illustrates positive rake angle on the insert; (b) illustrates a flat rake surface; and (c) is a sectional view of the insert from mid-section as illustrated by the cut-off line in (a) and (b), coolant passageways are revealed in (c), which are not visible in (a) and (b).

FIG. 3 is an isometric view of a specific embodiment of a screw-on insert and tool holder body that carries a cutting insert in a pocket and wherein the cutting tool assembly has a cutting tool body that carries a cutting insert, a lever, a screw, a shim, a shim pin, and a shim pin punch in this specific embodiment;

FIG. 4 is an isometric view of a specific embodiment of an oil/gas drilling tool that carries numerous circular inserts, which are often brazed to the tool holder.

FIG. 5 is a cross-sectional view of a cutting insert revealing its internal honeycomb structure;

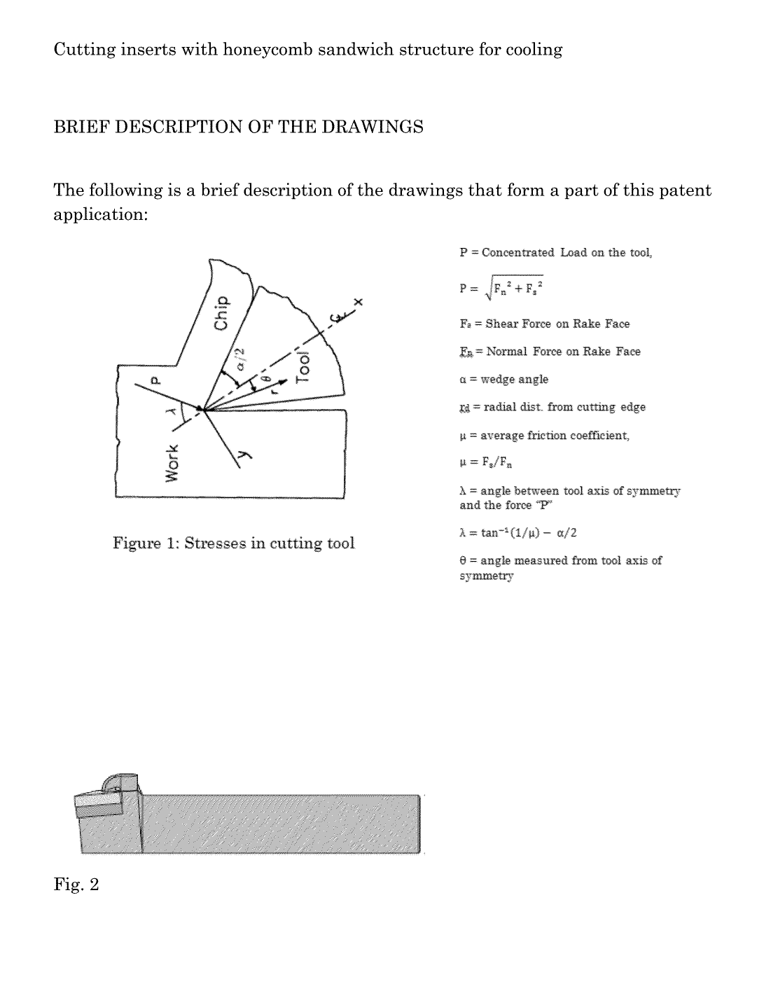

### DETAILED DESCRIPTION

Referring to the drawings, there should be an appreciation that the cutting insert of the invention, as well as the cutting assembly of the invention, can operate in a number of different applications. The cutting insert, which has internal coolant delivery, are for use in advanced material cutting, regular metal cutting, and oil/gas drilling. In this respect, the cutting insert is often used in a chip forming material removal operation wherein there is enhanced delivery of coolant adjacent the interface between the cutting insert and the work-piece (i.e., the insert-chip interface) to diminish excessive heat at the insert-chip interface.

The internal delivery of coolant to the insert body leads to certain advantages. For example, it results in lower temperature at the insert-chip interface which decreases the tendency of the chip to stick to the cutting insert.

The interior coolant passage discharge has an orientation whereby the coolant reaches beneath the rake face in the cutting zone. Such an orientation of the coolant enhances the cooling effects, which enhances the overall performance of the cutting insert.

The description herein of specific applications should not be a limitation on the scope and extent of the use of the cutting insert.

In the material removal operation, the cutting insert engages a work-piece to remove material from a work-piece. The following patent documents discuss the formation of chips in a material removal operation: U.S. Pat. No. 5,709,907 to Battaglia et al. (assigned to Kennametal Inc.), U.S. Pat. No. 5,722,803 to Battaglia et al. (assigned to Kennametal Inc.), and U.S. Pat. No. 6,161,990 to Oles et al. (assigned to Kennametal Inc.).

Referring to the drawings, FIG. 2 is an isometric view that shows a turning tool assembly that carries a cutting insert, a seat, a lock pin, a clamp, and a clamp screw in this specific embodiment. Cutting inserts can be in various shapes and configurations, two examples are given in FIG. 2A as (a) and (b), but other shapes and configurations are also commonly used as well, such as triangular, square, and circular shapes, to name a few, the insert can be single sided, or double sided too. View (c) in FIG. 2A is a sectional view, revealing the internal coolant passage ways, which are often in the mid-layer of an insert.

There should be an appreciation that any one of a number of different kinds of fluid or coolant is suitable for use in the cutting insert. Broadly speaking, there are two basic categories of fluids or coolants; namely, oil-based fluids which include straight oils and soluble oils, and chemical fluids which include synthetic and semisynthetic coolants. Straight oils are composed of a base mineral or petroleum oil and often contain polar lubricants such as fats, vegetable oils, and esters, as well as extreme pressure additives of chlorine, sulfur and phosphorus. Soluble oils (also called emulsion fluid) are composed of a base of petroleum or mineral oil combined with emulsifiers and blending agents Petroleum or mineral oil combined with emulsifiers and blending agents are basic components of soluble oils (also called emulsifiable oils). The concentration of listed components in their water mixture is usually between 30-85%. Usually the soaps, wetting agents, and couplers are used as emulsifiers, and their basic role is to reduce the surface tension. As a result they can cause a fluid tendency to foam. In addition, soluble oils can contain oiliness agents such as ester, extreme pressure additives, alkanolamines to provide reserve alkalinity, a biocide such as triazine or oxazolidene, a defoamer such as a long chain organic fatty alcohol or salt, corrosion inhibitors, antioxidants, etc. Synthetic fluids (chemical fluids) can be further categorized into two subgroups: true solutions and surface active fluids. True solution fluids are composed essentially of alkaline inorganic and organic compounds and are formulated to impart corrosion protection to water. Chemical surface-active fluids are composed of alkaline inorganic and organic corrosion inhibitors combined with anionic non-ionic wetting agents to provide lubrication and improve wetting ability. Extreme-pressure lubricants based on chlorine, sulfur, and phosphorus, as well as some of the more recently developed polymer physical extreme-pressure agents can be additionally incorporated in this fluids. Semisynthetics fluids (also called semi-chemical) contains a lower amount of refined base oil (5-30%) in the concentrate. They are additionally mixed with emulsifiers, as well as 30-50% of water. Since they include both constituents of synthetic and soluble oils, characteristics properties common to both synthetics and water soluble oils are presented.

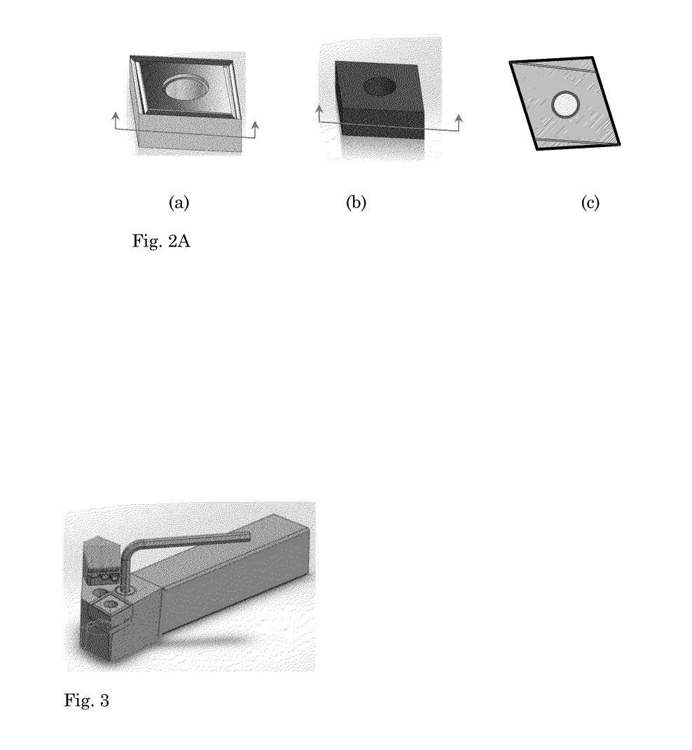

Referring to FIG. 3, which is an isometric view of a specific embodiment of a screw-on insert and tool holder body that carries a cutting insert in a pocket and wherein the cutting tool assembly has a cutting tool body that carries a cutting insert, a lever, a screw, a shim, a shim pin, and a shim pin punch in this specific embodiment. Cutting inserts can be in various shapes and configurations, two examples are given in FIG. 2A, but other shapes and configurations are also commonly used as well, such as triangular, square, and circular shapes, to name a few, the insert can be single sided, or double sided too.

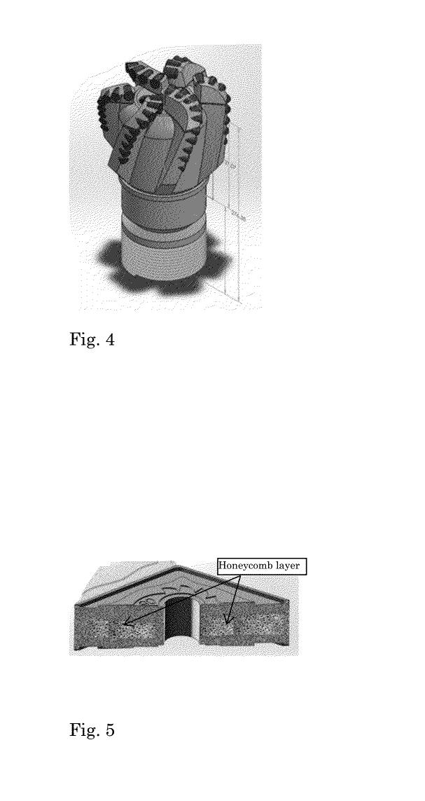

Referring to FIG. 4, which is an isometric view of a specific embodiment of an oil/gas drilling tool that carries numerous circular inserts brazed to the tool holder. Other shapes and configurations of the insert are not limited in the application. The insert materials can be materials consisting of carbon steels, high-speed steels, cast cobalt alloy, cemented carbides, cermets, alumina, cubic boron nitride, polycrystalline diamond (PCD), natural and synthetic diamond, ceramics by powder metallurgical techniques.

Referring to FIG. 5, which is a cross sectional view of a cutting insert, to reveal the honeycomb structure inside an insert, where numerous open pores are interconnected inside the insert with size of a few nanometers to a few millimeters, and their distribution inside the insert body could be evenly distributed, or randomly distributed, or more hole structure in the middle section of the insert with less and maybe also smaller holes toward the insert surfaces, such as rake face and flank face of the insert. Therefore, the insert provides adequate strength to withstand force and impact from cutting work-piece and also in the meantime provides effective cooling result to the cutting tool. All the sides of the insert (not the top or the bottom) could be sealed to prevent coolant from being wasted by flowing out there, but leave honeycomb structure opens at certain places on the side of the insert, such as some portion of the nose and the flank face of the insert. The coolant flows through an inner passageway from the tool holder directly to the honeycomb open on the insert, which could be on the side, top, and/or bottom of the insert. Connectors could be used between the tool holder and the insert to allow quick installation and desirable coolant flow between them.

In this preferred specific embodiment, it is apparent that the geometry of the coolant flow cross-sectional area of the interior coolant passage changes along the axial length of the interior coolant passages, i.e., the axial coolant passage length. Further, there should be an appreciation that the coolant flow cross-sectional area can vary to achieve a specific desired flow configuration near the insert-chip interface.

The choice of specific materials for the components is dependent upon the particular applications for the cutting insert. The use of ceramic-ceramic or carbide-carbide or steel-carbide combinations of the components provides the cutting insert with a variety of material options. By doing so, the cutting insert has an expansive material selection feature that allows for optimum customization of the cutting insert from the materials perspective.

The patents and other documents identified herein are hereby incorporated by reference herein. Other embodiments of the invention will be apparent to those skilled in the art from a consideration of the specification or a practice of the invention disclosed herein. It is intended that the specification and examples are illustrative only and are not intended to be limiting on the scope of the invention. The true scope and spirit of the invention is indicated by the claims.

What is claimed is:

1. A cutting insert for use in material removal and chip formation from a work-piece. The cutting insert comprising: a cutting insert body including at least a cutting edge, nose, rake face, and flank face. The cutting insert body comprises a sandwich structure with three-layer minimum as one functional insert body. In case of a three-layer-sandwich-structured insert body, the middle layer is about one third of (or more) the insert thickness and is fabricated in multi-layer honeycomb structure with many through holes roughly parallel to the insert rake face and one of the cutting edges, to allow coolant flow through. The surface layers (top and bottom) are about one third of the insert thickness each or less, solid in structure, made in the same way as conventional cutting inserts. The middle layer is separately manufactured from the surface layers, and they are assembled together by means such as, but not limited to, sintering or welding process. The sandwich structured insert provides adequate strength to withstand force and impact from cutting work-piece and also in the meantime provides effective cooling result to the cutting tool. Once the insert is assembled on a tool holder in a ready to cutting condition, the side(s) of the insert which are in direct contact with the tool holder are connected to the coolant flow channel(s) in the tool holder. The flank face of the insert could be sealed or partially sealed to reduce coolant flow volume.

2. The cutting insert according to claim 1 wherein its body could also be sandwiched in more than three layers. In case of a four-layer insert body, the two middle layers are in honeycomb structure with many through holes roughly parallel to the insert rake face and one of the cutting edges, to allow coolant flow through. They can be both or each connected to the coolant flow channels in the tool holder. The surface layers (top and bottom) are solid, made in the same way as conventional cutting inserts.

3. The cutting insert according to claim 1 wherein its body could also be sandwiched in more than three layers. In case of a five-layer insert body, the top, middle, and bottom layers are made in solid pieces, to withstand cutting force during cutting operation, the two layers between those three solid layers are in honeycomb structure with many through holes roughly parallel to the insert rake face and one of the cutting edges, to allow coolant flow through. The five-layer sandwich structured insert body are assembled together by means such as, but not limited to, sintering or welding process.

4. The cutting insert according to claim 1 wherein its body is often made from one of the materials selected from the group consisting of carbon steels, high-speed steels, cast cobalt alloy, cemented carbides, cermets, alumina, cubic boron nitride, polycrystalline diamond (PCD), natural and synthetic diamond, ceramics by powder metallurgical techniques.

5. The cutting tool assembly according to claim 1 wherein the tool holder are often being made from a different material as the cutting insert.

6. The cutting insert according to claim 1 wherein the body being detachably joined to the tool holder with screw and pin (such as clamp screw, shim screw, lock screw, adjust screw), a shim (or wedge lock) is usually placed in between the insert and the tool holder. Sometimes the insert is joined to the tool holder with a mechanical clamp, or brazed to the tool shank.

7. A cutting assembly for use in chip forming and material removal from a work-piece wherein a coolant source supplies coolant to the cutting assembly, the cutting assembly comprising: a tool holder comprising an internal channel as coolant passageway; the cutting insert comprising: a cutting insert body including cutting edge, nose, rake face, and flank face; a shim which is under the cutting insert; an aperture for receiving a fastener (called lock pin sometimes); the cutting insert body further containing sandwiched honeycomb structure inside allowing coolant passing through itself. However, the outside of the insert, including most part of the top face and the bottom face are not coolant permissible, except some portions on the side of the insert are also in honeycomb structure, allowing coolant going in from the tool holder.

8. The cutting tool assembly according to claim 1, which can be used as a turning tool on a lathe, or a drilling tool for mine/oil/natural gas exploration.
